(19) United States
(12) Patent Application Publication
(10) Pub. No.: US 2009/0153094 A1
(43) Pub. Date: Jun. 18, 2009

(54) DRIVE

(75) Inventor: Thomas HENKE, Borgholzhausen (DE)

Correspondence Address: PATENT CENTRAL LLC;Stephan A. Pendorf, 1401 Hollywood Boulevard, Hollywood, FL, 33020, US

(73) Assignee: Hanning Elektro-Werke GmbH & Co. KG, Oerlinghausen (DE)

(21) Appl. No.: 12/333,521

(22) Filed: Dec. 12, 2008

(30) Foreign Application Priority Data
Dec. 14, 2007 (DE) 10 2007 060 975.4

(51) Int. Cl. H02P 6/00

(52) U.S. Cl. 318/700

(57) ABSTRACT

The invention relates to a drive for simmering apparatus comprising an electric motor and a power converter arrangement which arrangement includes a rectifier unit, an intermediate circuit unit, an inverter unit and an electronic control unit wherein the inverter unit, the electronic control unit and the electric motor are combined into one common module that is arranged separate from a power input module comprising g the rectifier unit and the intermediate circuit.

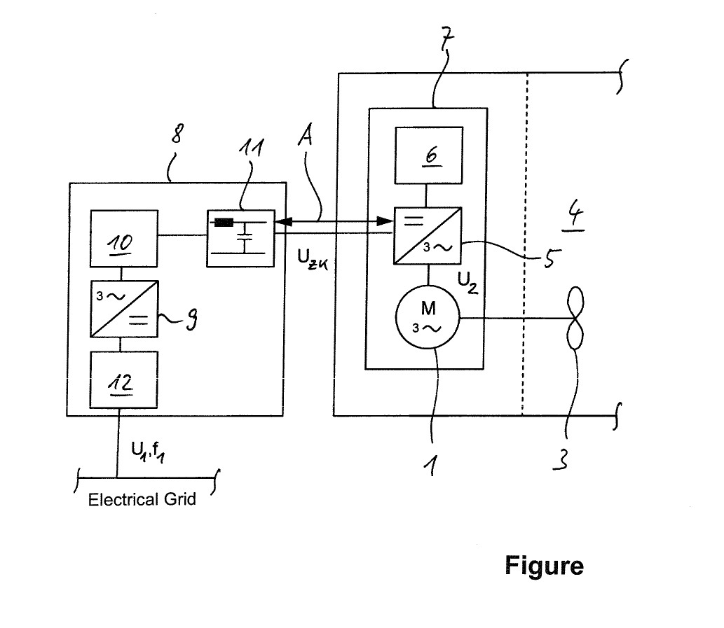

### BACKGROUND OF THE INVENTION

1. Field of the Invention

This present invention relates to a drive for a simmering apparatus which comprises an electric motor and a power converter arrangement which latter includes a rectifier unit, an intermediate circuit unit, an inverter unit and an electronic control unit.

Steam operated simmering apparatus (convectomats, combination simmering units) with electric or gas heating systems are being used for professional cooking to an ever increasing extent in restaurants and canteen kitchens. An electric motor driven blower is provided to generate simmering air having temperatures up to 300° C. in the simmering steam compartment of a simmering apparatus. To make the drive for this blower substantially compact it has become a more and more customary practice to use electric motors of permanent magnet synchronous type which are operated in coaction with a static power converter arrangement. Such a static power converter arrangement normally comprises a frequency converter with line-side rectifier unit, an intermediate circuit unit, a load-side inverter unit and an electronic control unit.

2. Related Art of the Invention

Prior known from DE 101 47 472 A1 is a drive comprising an electric motor and a power converter arrangement in which the components of the converter arrangement are separate from one another. One module consists of a rectifier unit, an intermediate circuit unit and an inverter unit. Another module comprises an electronic control unit that goes with the electric motor. Thermal isolation may be achieved by such separate arrangement of rectifier, intermediate circuit unit and inverter with the result that the electronic control unit is no longer being detrimentally influenced by heat radiation and/or heat conduction via the power semiconductors of the rectifier unit and the inverter unit. It is possible also to operate the power converter arrangement at very high ambient temperatures since besides the electric motor it is only the electronic control unit that can be arranged close to the simmering compartment. The prior known drive is however affected by the drawback that its operational flexibility is restricted. The power semiconductors of the converter arrangement are rated for operation at predetermined system voltages and frequencies such as 100 V, 240 V, 360 V or 480 V and/or 50 Hz or 60 Hz. For use of the steam simmering equipment in the United States of America and in Germany, for instance, it would be necessary to exchange substantially the entire converter arrangement including the rectifier unit, the intermediate circuit unit and the inverter unit.

### SUMMARY OF THE INVENTION

It is an object of this present invention, therefore, to improve a drive consisting of an electric motor and a power converter arrangement in such a way that the extent of provisions to be made for universal use of the drive under different system or line conditions is reduced.

To achieve this object the invention is in conjunction with the generic clause of Claim 1 characterized by the fact that the rectifier unit, the electronic control unit and the electric motor are combined into one module which is arranged separate from the power input module comprising the rectifier unit and the intermediate circuit.

The particular advantage of the invention resides in that the flexibility of the drive in terms of operating modes is increased. The root idea underlying the invention is to provide functional and spatial separation of a power converter arrangement by combining a rectifier unit and an intermediate circuit unit substantially into a power input module which is spatially separated from further components of the power converter arrangement and/or from the motor. It is practicable according to the invention to have the power input module adapted to specific feed conditions. Such conditions may for instance be the feed voltage and/or the feed frequency or a demand for or compliance with legal provisions regarding electromagnetic compatibility. The inverter unit constitutes a compact module together with the electric motor and the electronic control unit whose configuration remains unchanged at all time irrespective of what feed conditions may be existing.

In a preferred embodiment of the invention the power input module is designed to suit a specific line input voltage and/or frequency. While the setup of the inverter unit remains unchanged, the components of the power input module are adapted to the feed and/or system conditions given in every particular case. This means that different power input modules comprising different elements (power semiconductors) adapted to different line conditions may be used for different networks. Different power input modules may hence be selectively combined with the inverter unit and the electronic control unit to suit specific conditions of the line.

According to an improvement of the invention the power input module is designed such that at one output thereof an intermediate circuit voltage having a constant level will be generated. This means that the inverter unit associated with the electric motor may remain unchanged for different feed conditions when a constant voltage level is ensured. The intermediate circuit voltage level is adapted to the rating of the motor such that the same electric motor and/or inverter unit can be used for different networks at all time.

In an another modification of the invention the power input module is fitted with a mains filter of a type ensuring that any requirements as to electromagnetic compatibility will be satisfied. This means that dependent on specific feed conditions which call for compliance with legal requirements regarding electromagnetic compatibility also a different type of mains filter may be adopted for different networks which cuts down the extent of filter arrangements.

A further improvement of this invention provides for the power input module to include a converter unit by means of which an intermediate circuit constant-level voltage may be generated. This constant voltage level may be in a range of 300±20 V. The advantage offered thereby is that inverter unit and electric motor may be operated on different line voltages between 100 V and 480 V.

According to one last improvement of this present invention the power input module will be arranged in such a distance from the assembly and/or a simmering compartment of a steam-operated simmering apparatus that the operating temperature of the power input module is below a predetermined threshold value. This threshold value may be as low as 90° C., for instance. This offers the advantage that cooling needs are reduced and a reliable operation of the drive over extended periods of time will be ensured.

Further advantages of the invention are as defined in the subclaims.

### BRIEF DESCRIPTION OF THE DRAWING

One exemplary embodiment of this present invention will now be described with reference to the accompanying drawing.

The FIGURE shows a block diagram of a drive according to this invention.

### DETAILED DESCRIPTION OF THE INVENTION

A drive for simmering apparatus comprises an electric motor 1 and a power converter arrangement 2.

The electric motor 1 is a three-phase synchronous motor which is via a drive shaft coupled with an impeller 3 to circulate hot air in a simmering compartment 4 of a simmering apparatus. The simmering unit may be of steam operated type wherein said impeller 3 may be used also for steam generation by applying water to the comparatively hot blades of said impeller 3.

Together with an inverter unit and an electronic control unit the electric motor 1 forms one common module 7 which is mounted immediately behind or aside the simmering compartment. The electronic control unit 6 may for instance comprise a signal electronic system (microcomputer respectively microcontroller) by which the inverter unit 5 and/or the electric motor 1 is triggered. The inverter unit 5 may include an intermediate circuit buffer, a driver circuit and/or an inverter high-level output stage.

In a distance A from said module 7 there is a power input module 8 disposed which substantially comprises a rectifier unit 9, a converter unit 10, an intermediate circuit unit 11 and a filter unit 121. The power supply unit 8 is arranged on that side of module 7 which is facing away from the simmering compartment 4 and the distance A is preferably at least 0.5 m to make sure that the working temperature of the power input mo-dule 8 can be kept below a predetermined threshold value of 90° C. for instance. This distance A may be shorter when the opposing enclosure walls of power input module 8 and module 7 are heat insulated and in case of restricted space availability may be a few millimeters or even zero provided an adequate heat insulation is provided. The opposing enclosure walls of power input module 8 and module 7 are in direct contact with each other when said distance A is zero.

The input side of the power input module 8 is connected to a power supply system that provides a three-phase mains voltage U₁ at a frequency f₁. The mains voltage U₁ may be 230 V and the mains frequency f₁ may be 50 Hz, for instance. Alternatively, the power input module 8 may be connected to a battery or some other power source.

The rectifier unit 9 preferably comprises a line-commuted rectifier and an active control circuit for power factor correction which converts the mains input voltage U₁ into a DC voltage. Disposed downstream the rectifier 9 is a converter unit 10 which may for instance comprise an up-converter (step-up switching regulator) or a down-converter (step-down switching regulator) for providing a constant-level voltage U_{ZK} on the output side of the power input module 8. The intermediate circuit 11 includes ate least one coil and one capacitor such that the electric energy as fed may be buffered while providing the constant voltage level U_{ZK}.

The filter unit 12 comprises at least one mains filter that improves particularly the electromagnetic compatibility of the simmering apparatus in case of disturbances from the network. Said mains filter may also be rated such that electric mains interference may be restricted. The inverter unit 5 comprises an inverter rated for a motor rated voltage U₂. It is designed such as to enable generation of the predetermined three-phase motor rated voltage U₂ from the intermediate circuit voltage U_{ZK}.

Dependent on the feed conditions of the simmering apparatus, especially in terms of different power supply parameters such as 100 V-230 V 50 Hz/60 Hz 1˜ or 360 V-480 V 50/60 Hz 3˜ there is a reconfiguration of the power input module achieved to the effect that rectifier unit 9 and/or converter unit 10 are adapted to the feed conditions and/or type of feeding involved in every particular case. The design of the filter unit 12 is as well tuned to the feed conditions, especially for compliance with legal provisions regarding electromagnetic compatibility. This means that a drive may be flexibly made available for a variety of applications while the module 7 has the same configuration in all cases and is integrated in the steam-operated simmering apparatus. The power input module 8, too, is integrated in the enclosure or casing of said simmering apparatus, though arranged in a spaced relation from the electric motor 1 and within a casing marginal area to thereby facilitate access thereto and/or an exchange thereof.

The drive according to this present invention can be used for any type of motor operated equipment where there is a high load involved in the motor area on the one hand and a relatively great variety of feed conditions and filter requirements exist. The drive of the invention may for instance be used as a pump drive in the home appliance field such as for dishwashers. In addition it can be used for laboratory, medical or industrial applications. This drive of the present invention offers a higher degree of modularity in the configuration of motor operated equipment.

1. A drive for a simmering apparatus which comprises an electric motor and a power converter arrangement which latter includes a rectifier unit, an intermediate circuit unit, an inverter unit and an electronic control unit, wherein the rectifier unit (5), the electronic control unit (6) and the electric motor (1) are combined into one module which is arranged separate from the power input module (8) comprising the rectifier unit (9) and the intermediate circuit (11).

2. The drive according to claim 1, wherein the power input module (8) comprises a circuit arrangement that is adapted to a given mains voltage (U₁) and a mains frequency (f₁).

3. The drive according to claim 1, wherein the configuration of the power input module (8) is such that an intermediate circuit voltage (U_{ZK}) having a constant level (U_{ZK}) adapted to the rating of the electric motor (1) and/or the inverter unit (5) can be generated at an output thereof.

4. The drive according to claim 1, wherein the power input module (8) is provided with a filter unit (12) of a type ensuring compliance with existing requirements regarding electromagnetic compatibility dependent on given feed parameters.

5. The drive according to claim 1, wherein the power input module (8) comprises a converter unit (10) such that a constant-level intermediate circuit voltage (U_{ZK}) can be generated at the output of said power input module (8).

6. The drive according to claim 1, wherein the rectifier unit (9) is a line-commuted rectifier.

7. The drive according to claim 1, wherein the inverter unit (5) comprises an inverter that is rated for the rated voltage (U₂) of the electric motor (1).

8. The drive according to claim 1, wherein the power input module (8) is arranged at such a distance (A) from module (7) and/or a simmering compartment (4) of the steam operated simmering apparatus that the working temperature of said power input module (8) is below a predetermined threshold value.

9. The drive according to claim 1, wherein the electric motor (1) is of three-phase synchronous type.

10. The drive according to claim 1, wherein the distance (A) between the power input module (8) and module (7) is zero.
